(19) United States
(12) Patent Application Publication
(10) Pub. No.: US 2023/0084663 A1
(43) Pub. Date: Mar. 16, 2023

(54) AEROSOL GENERATING DEVICE

(71) Applicant: KT&G CORPORATION, Daejeon (KR)

(72) Inventors: Dong Sung KIM, Seoul (KR); Heon Jun JEONG, Seoul (KR); Won Kyeong LEE, Gyeonggi-do (KR); Jae Sung CHOI, Gyeonggi-do (KR)

(73) Assignee: KT&G CORPORTION, Daejeon (KR)

(21) Appl. No.: 17/801,336

(22) PCT Filed: Nov. 25, 2021
(86) PCT No.: PCT/KR2021/017530

§ 371 Date: Aug. 22, 2022

(30) Foreign Application Priority Data
Dec. 4, 2020 (KR) 10-2020-0168735
Feb. 18, 2021 (KR) 10-2021-0022029

(51) Int. Cl. A24F 40/05; A24F 40/42; B06B 1/06; B05B 17/06

(52) U.S. Cl. CPC A24F 40/05; A24F 40/42; B06B 1/0603; B05B 17/0653; B06B 2201/77

(57) ABSTRACT

Discloses is an aerosol generating device including: a main body; a cartridge detachably coupled to the main body and configured to contain an aerosol generating material; and an ultrasonic vibrator arranged in the cartridge, comprising electrodes on different surfaces, and configured to vibrate the aerosol generating material, wherein the electrodes are formed on the ultrasonic vibrator by deposition.

### TECHNICAL FIELD

One or more embodiments of the present disclosure relate to a cartridge and an aerosol generating device including the same, and more particularly, to an aerosol generating device including an ultrasonic vibrator configured to generate an aerosol by vibrating an aerosol generating material.

### BACKGROUND ART

There is growing demand for an aerosol generating device that generates an aerosol in a non-combustible manner as an alternative to aerosol generating devices that burn a cigarette to generate an aerosol. An aerosol generating device generates an aerosol from an aerosol generating material in a non-combustible manner and supplies the aerosol to a user.

In the aerosol generating device, an ultrasonic vibrator may he used to atomize an aerosol generating article. The ultrasonic vibrator does not directly generate heat, but may generate vibrations when power is applied, to atomize the aerosol generating material into small particles, thereby generating an aerosol.

### DISCLOSURE OF INVENTION

### Technical Problem

The ultrasonic vibrator includes electrodes connected to a power supply device. Therefore, the electrodes need to be arranged in such a way that the ultrasonic vibrator can be easily connected to and disconnected from the power supply device.

Also, there is a need for an ultrasonic vibrator having good corrosion resistance and abrasion resistance.

The technical problems of the present disclosure are not limited to the above-described description, and other technical problems may be derived from the embodiments to be described hereinafter.

### Solution to Problem

An aerosol generating device according to an embodiment includes a main body; a cartridge detachably coupled to the main body and configured to contain an aerosol generating material; an ultrasonic vibrator arranged in the cartridge, comprising electrodes on different surfaces, and configured to vibrate the aerosol generating material, wherein the electrodes are formed on the ultrasonic vibrator by deposition.

### Advantageous Effects of Invention

The aerosol generating device according to the embodiments is excellent in stability because the electrodes of the ultrasonic vibrator configured to atomize the aerosol are deposited on the ultrasonic vibrator, so that the ultrasonic vibrator does not easily corrode or wear out by the aerosol generating material.

In addition, in the aerosol generating device according to the embodiments, the electrodes of different polarities are arranged on the same surface of the ultrasonic vibrator, so that it is easy to connect the ultrasonic vibrator to the power supply device and an internal structure of the ultrasonic vibrator is simplified. As a result, the ultrasonic vibrator may be easily attached to and detached from the power supply device.

The advantageous effects of the present disclosure are not limited to the above-described description, and other technical problems may be derived from the embodiments to be described hereinafter.

### BRIEF DESCRIPTION OF DRAWINGS

FIG. 1 is a block diagram of an aerosol generating device, according to an embodiment.

FIG. 2 is a schematic diagram illustrating an aerosol generating device, according to the embodiment shown in FIG. 1.

FIG. 3 is a perspective view of an aerosol generating device, according to an embodiment.

FIG. 4 is a perspective view of a cartridge of an aerosol generating device according to the embodiment shown in FIG. 3.

FIG. 5 is a cross-sectional view taken along line V-V′ of FIG. 4.

FIGS. 6A and 6B are perspective views of an ultrasonic vibrator of an aerosol generating device, according to an embodiment.

FIG. 7A is a perspective view of an ultrasonic vibrator of an aerosol generating device, according to another embodiment.

FIG. 7B is a rear perspective view of the ultrasonic vibrator of the aerosol generating device, according to another embodiment.

FIG. 8 is a schematic side view of the ultrasonic vibrator shown in FIGS. 7A and 7B.

FIG. 9A is a perspective view of an ultrasonic vibrator of an aerosol generating device, according to another embodiment.

FIG. 9B is a schematic side view of the ultrasonic vibrator of the aerosol generating device, according to another embodiment.

FIG. 10 is an enlarged partial view of a cartridge shown in FIG. 5.

FIG. 11 is a schematic diagram illustrating an ultrasonic vibrator and a fixing member shown in FIG. 10.

### BEST MODE FOR CARRYING OUT THE INVENTION

An aerosol generating device according to an embodiment includes a main body; a cartridge detachably coupled to the main body and configured to contain an aerosol generating material; and an ultrasonic vibrator arranged in the cartridge, comprising electrodes on different surfaces, and configured to vibrate the aerosol generating material, wherein the electrodes are formed on the ultrasonic vibrator by deposition.

Thicknesses of the electrodes may be 0.5 μm to 5 μm.

The ultrasonic vibrator may include a first electrode arranged on a first surface of the ultrasonic vibrator and a second electrode arranged on a second surface of the ultrasonic vibrator, wherein the first electrode and the second electrode may be electrically insulated from each other.

The first electrode may extend from the first surface to the second surface, covering at least a portion of a side surface of the ultrasonic vibrator, and the first electrode may he apart from the second electrode on the second surface such that the first electrode is electrically insulated from the second electrode.

A battery may be electrically connected to the first electrode and the second electrode which are deposited on the second surface of the ultrasonic vibrator.

The first electrode may extend from the first surface to the second surface, covering at least a portion of a side surface of the ultrasonic vibrator, and the ultrasonic vibrator may include an insulator extending from the side surface to the second surface and arranged between the first electrode and the second electrode on the second surface such that the first electrode is electrically insulated from the second electrode.

In addition, on the second surface of the ultrasonic vibrator, an area of the insulator may be greater than or equal to an area of the first electrode.

The cartridge may include a fixing member configured to fix the ultrasonic vibrator in the cartridge, and the fixing member may include a hollow extending in a longitudinal direction and an insertion portion recessed in a direction crossing the hollow, such that a portion of the ultrasonic vibrator is inserted into the insertion portion.

The electrode may include the first electrode and the second electrode, wherein the first electrode is deposited on a first surface of the ultrasonic vibrator and extends to a second surface of the ultrasonic vibrator, covering at least a portion of a side surface of the ultrasonic vibrator.

In a side view of the cartridge, a length of the first electrode on the second surface may be greater than a length of the insertion portion such that the first electrode on the second surface is exposed to the hollow when the portion of the ultrasonic vibrator is inserted into the insertion portion.

The second electrode may be deposited on the second surface of the ultrasonic vibrator and electrically insulated from the first electrode.

A diameter of the hollow may be smaller than a diameter of the ultrasonic vibrator.

An aerosol generating device according to another embodiment includes a main body; a cartridge detachably coupled to the main body and configured to contain an aerosol generating material; an ultrasonic vibrator arranged in the cartridge and configured to vibrate the aerosol generating material; a first electrode deposited on a first surface and a second surface of the ultrasonic vibrator; and a second electrode deposited on the second surface of the ultrasonic vibrator.

The first electrode may extend from the first surface to the second surface, covering a side surface of the ultrasonic vibrator, and the second electrode may be apart from the first electrode on the second surface such that the first electrode is electrically insulated from the first electrode.

### Mode for the Invention

With respect to the terms used to describe the various embodiments, general terms which are currently and widely used are selected in consideration of functions of structural elements in the various embodiments of the present disclosure. However, meanings of the terms can be changed according to intention, a judicial precedence, the appearance of new technology, and the like. In addition, in certain cases, a term which is not commonly used can be selected. in such a case, the meaning of the term will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and/or operation and can be implemented by hardware components or software components and combinations thereof.

As used herein, expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

Hereinafter, the present disclosure will now be described more fully with reference to the accompanying drawings, in which exemplary embodiments of the present. disclosure are shown such that one of ordinary skill in the art may easily work the present disclosure. The disclosure can, however, be embodied in many different forms and should not be construed as being limited to the embodiments set forth herein.

Hereinafter, embodiments of the present disclosure will be described in detail with reference to the drawings.

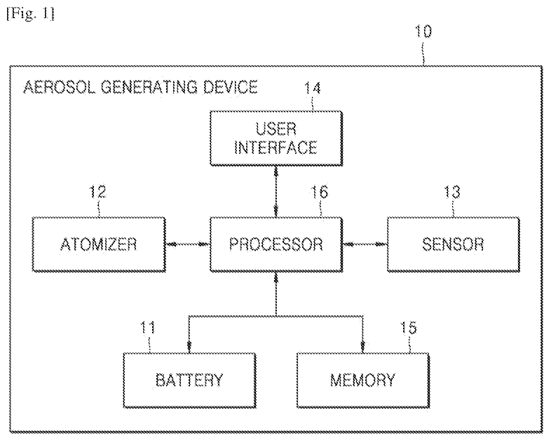

FIG. 1 is a block diagram of an aerosol generating device, according to an embodiment.

Referring to FIG. 1, an aerosol generating device 10 may include a battery 11, an atomizer 12, a sensor 13, a user interface 14, a memory 15, and a processor 16, However, an internal structure of the aerosol generating device 10 is not limited thereto. Those of ordinary skill in the art related to the present embodiments may understand that according to a design of the aerosol generating device 10, some of hardware components shown in FIG. 1 may be omitted or a new configuration may be further added.

As an example, the aerosol generating device 10 may include a main body, and hardware elements of the aerosol generating device 10 may be installed in the main body.

As another embodiment, the aerosol generating device 10 may include the main body and a cartridge, and the hardware elements of the aerosol generating device 10 may be located dispersedly in the main body and the cartridge. Alternatively, some of the hardware elements may be arranged in the main body and the cartridge.

Hereinafter, an operation of each element will be described without limiting a space on which each element included in the aerosol generating device 10 is located.

The battery 11 supplies power required to operate the aerosol generating device 10. That is, the battery 11 may supply power to allow the atomizer 12 to atomize an aerosol generating material. The battery 11 may also supply power necessary for operations of other hardware elements included in the aerosol generating device 10, such as the sensor 13, the user interface 14, the memory 15, and the processor 16. The battery 11 may be a rechargeable battery or a disposable battery.

For example, examples of the battery 11 may include a nickel-based battery (e.g., a nickel-metal hydride battery, a nickel-cadmium battery), or a lithium-based battery (e.g., a lithium-cobalt battery, a lithium-phosphate battery, a lithium titanate battery, a lithium ion battery or a lithium-polymer battery). However, examples of the battery 11 to be used in the aerosol generating device 10 are not limited thereto. Examples of the battery 11 may also include an alkaline battery or a manganese battery, when necessary.

The atomizer 12 receives power from the battery 11 under the control of the processor 16. The atomizer 12 may receive power from the battery 11 to atomize the aerosol generating material stored in the aerosol generating device 10.

The atomizer 12 may be arranged in the main body of the aerosol generating device 10. Alternatively, when the aerosol generating device 10 includes the main body and the cartridge, the atomizer 12 may be arranged in the cartridge or divided into the main body and the cartridge. When the atomizer 12 is arranged in the cartridge, the atomizer 12 may receive power from the battery 11 arranged in the main body or the cartridge. In addition, when the atomizer 12 is arranged across the main body and the cartridge, a part of the atomizer 12 that requires power supply may receive power from the battery 11 arranged in the main body or the cartridge.

The atomizer 12 generates an aerosol from the aerosol generating material in the cartridge. An aerosol refers to a suspension in which liquids and/or solid fine particles are dispersed in a gas. Therefore, the aerosol generated from the atomizer 12 may refer to a mixture of air and the particles vaporized from the aerosol generating material. The atomizer 12 may convert a phase of the aerosol generating material into a gaseous phase through vaporization and/or sublimation. For example, the atomizer 12 may generate an aerosol by atomizing the aerosol generating material in a liquid and/or solid phase.

According to an embodiment, the atomizer 12 may generate an aerosol from the aerosol generating material by an ultrasonic vibration method. In this case, the aerosol generating material may be atomized into an aerosol by ultrasonic vibrations generated by a vibrator.

Although not shown in FIG. 1, the atomizer 12 may optionally include a heater capable of heating the aerosol generating material by generating heat. The aerosol generating material may be heated by the heater, thereby generating an aerosol.

The heater may be formed of any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, or nichrome, but is not limited thereto. In addition, the heater may be implemented by a metal heating wire, a metal heating plate on which an electrically conductive track is arranged, a ceramic heating element, and the like, but is not limited thereto.

For example, according to an embodiment, the heater may be part of a cartridge 200. The cartridge 200 may include a liquid delivery means and a liquid storage portion, which will be described later. The aerosol generating material contained in the liquid storage portion may be absorbed by the liquid delivery means, and the heater may heat the aerosol generating material absorbed in the liquid delivery means to generate an aerosol. For example, the heater may be wound around the liquid delivery means or arranged adjacent to the liquid delivery means,

As another example, the aerosol generating device 10 may include an accommodation space capable of accommodating a cigarette, and the heater may heat the cigarette inserted into the accommodation space of the aerosol generating device 10. As the cigarette is accommodated in the accommodation space of the aerosol generating device 10, the heater may be located inside and/or outside the cigarette. Thereby, the heater may heat the aerosol generating material in the cigarette to generate an aerosol.

The heater may be an induction heating-type heater. The heater may include an electrically conductive coil configured to heat the cigarette or the cartridge in an induction heating manner, and the cigarette or the cartridge may include a susceptor to be heated by the induction heating-type heater.

The aerosol generating device 10 may include at least one sensor 13. The at least one sensor 13 may send its sensing result to the processor 16 According to the sensed result, the processor 16 may control the aerosol generating device 10 to perform various functions such as controlling an operation of the atomizer 12, restricting smoking, judging whether a cartridge (or cigarette) is being inserted or not, displaying notification, and the like.

For example, the at least one sensor 13 may include a puff detection sensor. The puff detection sensor may detect a user's puff based on at least one of a change in flow rate of an air flow introduced from the outside, a change in pressure, and detection of a sound. The puff detection sensor may detect a start time and an end time of the user's puff, and the processor 16 may, judge a puff period and a non-puff period according to the detected start time and end time of the detected puff.

The at least one sensor 13 may also include a user input sensor. The user input sensor may receive a user input, such as a switch, a physical button, a touch sensor, or the like. For example, when the user touches a certain area formed of a metal material, there may be a change in capacitance and the touch sensor may be a capacitive sensor capable of detecting the user input by detecting the change in capacitance. The processor 16 may determine whether the user input has occurred by comparing values before and after the change in capacitance received from the capacitive sensor. When the values before and after the change in capacitance exceed a predetermined threshold, the processor 16 may determine that the user input has occurred.

The at least one sensor 13 may also include a motion sensor. Information regarding a movement of the aerosol generating device 10 such as inclination, a moving speed, and acceleration of the aerosol generating device 10 may be obtained through the motion sensor. For example, the motion sensor may measure information regarding a state in which the aerosol generating device 10 moves, a stationary state of the aerosol generating device 10, a state in which the aerosol generating device 10 is tilted at an angle within a certain range for puffs, and a state in which the aerosol generating device 10 is tilted at an angle different from an angle during a puff operation between each of puff operations. The motion sensor may also measure motion information of the aerosol generating device 10 using various methods known in the art. For example, the motion sensor may include an acceleration sensor capable of measuring acceleration in three directions, such as an x-axis, a y-axis, and a z-axis, and a gyro sensor capable of measuring angular velocity in the three directions.

The at least one sensor 13 may also include a proximity sensor. The proximity sensor refers to a sensor configured to detect the presence or distance of an approaching object or an object existing in the vicinity using a force of an electromagnetic field or infrared rays, etc., without any mechanical contacts, and thus, it may be detected whether or not the user is approaching the aerosol generating device 10.

The at least one sensor 13 may also include an image sensor. The image sensor may include, for example, a camera configured to acquire an image of an object. The image sensor may recognize the object based on the image acquired by the camera. The processor 16 may analyze the image acquired through the image sensor to determine whether the user is going to use the aerosol generating device 10 or not. For example, when the user places the aerosol generating device 10 near his or her lips to use the aerosol generating device 10, the image sensor may acquire an image of his or her lips. The processor 16 may determine that the user is going to use the aerosol generating device 10 when determining the acquired image as his or her lips after analyzing the acquired image. Accordingly, the aerosol generating device 10 may pre-operate the atomizer 12 or preheat the heater.

The at least one sensor 13 may also include a consumable detachment sensor capable of detecting attachment or removal of a consumable (e.g., cartridge, cigarette, etc.) that may be used in the aerosol generating device 10. For example, the consumable detachment sensor may detect whether or not the consumable has contacted the aerosol generating device 10 or determine whether or not the consumable has been removed by the image sensor. The consumable detachment sensor may be an inductance sensor configured to detect a change in an inductance value of a coil capable of interacting with a marker of the consumable, or a capacitance sensor configured to detect a change in a capacitance value of a capacitor capable of interacting with the marker of the consumable.

The at least one sensor 13 may also include a temperature sensor. The temperature sensor may sense a temperature at which the heater (or the aerosol generating material) of the atomizer 12 is heated. The aerosol generating device 10 may include a separate temperature sensor configured to detect a temperature of the heater, or the heater itself may serve as the temperature sensor instead of the separate temperature sensor. Alternatively, a separate temperature sensor may be further included in the aerosol generating device 10 while the heater serves as the temperature sensor. The temperature sensor may detect temperatures of internal components such as a printed circuit board (PCB) and a battery of the aerosol generating device 10 as well as the temperature of the heater.

The at least one sensor 13 may also include various sensors configured to measure information regarding the surrounding environment of the aerosol generating device 10. For example, the at least one sensor 13 may also include a temperature sensor capable of measuring a temperature of the surrounding environment, a humidity sensor configured to measure a humidity of the surrounding environment, and an atmospheric pressure sensor configured to measure a pressure of the surrounding environment.

Examples of the sensor 13 that may be provided in the aerosol generating device 10 are not limited thereto, and the sensor 13 may further include other various sensors. For example, the aerosol generating device 10 may include a fingerprint sensor capable of acquiring fingerprint information from the user's finger for user authentication and security, an iris recognition sensor configured to analyze an iris pattern of the user's pupil, a vein recognition sensor configured to detect an amount of infrared absorption of reduced hemoglobin in veins from images taken from the user's palm, a facial recognition sensor configured to recognize features such as the user's eyes, nose, mouth, and facial contours in a two dimensional (2D) or 3D method, a radio-frequency identification (RFID) sensor, and the like.

In the aerosol generating device 10, only some of the various examples of the sensor 13 described above may be selected and implemented. In other words, the aerosol generating device 10 may combine and utilize information sensed by at least one of the above-described sensors.

The user interface 14 may provide the user with information on a state of the aerosol generating device 10. The user interface 14 may include various interfacing means such as a display or lamp for outputting visual information, a motor for outputting tactile information, a speaker for outputting sound information, an input/output (I/O) interfacing means (e.g., button or touch screen) for receiving information input from the user or outputting information to the user, terminals for data communication or for receiving charging power, a communication interfacing module for performing wireless communication with an external device (e.g., wireless fidelity (Wi-Fi), Wi-Fi direct, blue-tooth, near-field communication (NFC)), and the like.

However, in the aerosol generating device 10, only some of the various examples of the user interface 14 described above may be selected and implemented.

The memory 15 is hardware configured to store various data processed in the aerosol generating device 10, and may store data processed and data to be processed by the processor 16. The memory 15 may be implemented by a variety types of random access memory (RAM) such as dynamic random access memory (DRAM), static random access memory (SRAM), and the like, read-only memory (ROM), electrically erasable programmable read-only memory (EEPROM), and the like.

The memory 15 may store an operation time of the aerosol generating device 10, a maximum number of puffs, a current number of puffs, at least one temperature profile, data on the user's smoking pattern, and the like.

The processor 16 controls the overall operation of the aerosol generating device 10. The processor 16 may be implemented by an array of a plurality of logic gates, or may be implemented by a combination of a general-purpose microprocessor and a meniory in which a program executable in the microprocessor is stored. In addition, those skilled in the art may understand that the processor 16 may be implemented by other types of hardware.

The processor 16 analyzes a result sensed by the at least one sensor 13 and controls processes to be subsequently performed.

The processor 16 may control power supply to the atomizer 12 to start or end an operation of the atomizer 12 based on the result sensed by the at least one sensor 13. The processor 16 may also control, based on the result sensed by the at least one sensor 13, an amount and time of power supply to the atomizer 12 such that the atomizer 12 may generate an appropriate amount of aerosol. For example, the processor 16 may control a current or voltage supplied to a vibrator such that the vibrator of the atomizer 12 vibrates at a certain frequency.

According to an embodiment, the processor 16 may start the operation of the atomizer 12 after receiving the user input for the aerosol generating device 10. The processor 16 may also start the operation of the atomizer 12 after detecting the user's puff using the puff detection sensor. In addition, the processor 16 may suspend power supply to the atomizer 12 when the number of puffs reaches a predetermined number after counting the number of puffs using the puff detection sensor.

The processor 16 may control the user interface 14 based on the result sensed by the at least one sensor 13. For example, when the number of puffs reaches the predetermined number after counting the number of puffs using the puff detection sensor, the processor 16 may inform the user that the aerosol generating device 10 will soon be shut down using at least one of the lamp, the motor, and the speaker.

Although not shown in FIG. 1, the aerosol generating device 10 may be coupled to a separate cradle to form an aerosol generating system. For example, the cradle may be used to charge the battery 11 of the aerosol generating device 10. For example, the aerosol generating device 10 may receive power from a battery of the cradle to charge the battery 11 of the aerosol generating device 10 while accommodated in an accommodation space in the cradle.

An embodiment may also be implemented in the form of a recording medium including instructions executable by a computer, such as a program module executed by a computer. A computer-readable medium may be any available medium that can be accessed by a computer, and includes both volatile and nonvolatile media and removable and non-removable media, The computer-readable media may also include both computer storage media and communication media. The computer storage media include all of volatile and nonvolatile, and removable and non-removable media implemented by any method or technology for storage of information such as computer-readable instructions, data structures, program modules or other data. The communication media typically includes computer-readable instructions, data structures, other data in modulated data signals, such as program modules, or other transport mechanisms, and includes any information delivery media.

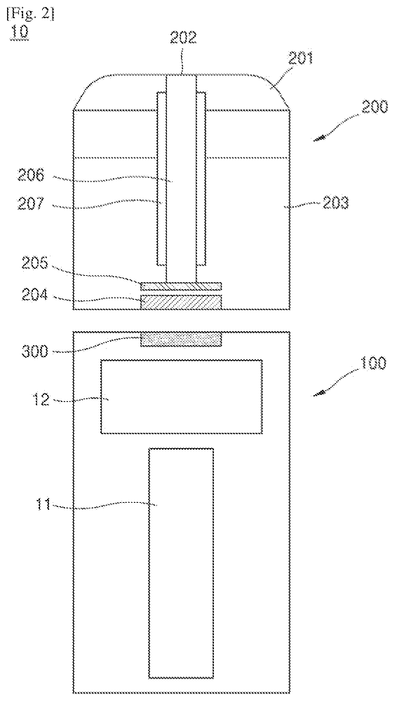

FIG. 2 is a schematic diagram illustrating an aerosol generating device, according to an embodiment.

The aerosol generating device 10 according to the embodiment shown in FIG. 2 includes the cartridge 200 configured to contain an aerosol generating material, and a main body 100 configured to support the cartridge 200.

The cartridge 200 may include a mouthpiece 201. One end portion of the mouthpiece 201 may be coupled to the main body 100, and the mouthpiece 201 may be formed at the opposite end portion. The mouthpiece 201 may be inserted into a users oral cavity. The mouthpiece 201 may include a discharge hole 202 configured to discharge to the outside an aerosol generated from the aerosol generating material in the cartridge 200.

The cartridge 200 may contain the aerosol generating material having any one state, such as a liquid state, a solid state, a gaseous state, or a gel state. The aerosol generating material may include a liquid composition. For example, the liquid composition may be a liquid including a tobacco-containing material including a volatile tobacco flavor component, or may be a liquid including a non-tobacco material.

For example, the liquid composition may include one component of water, solvents, ethanol, plant extracts, spices, flavorings, and vitamin mixtures, or a mixture of these components. The spices may include menthol, peppermint, spearmint oil, and various fruit flavoring ingredients. However, embodiments of the present disclosure are not limited thereto. The flavorings may include ingredients capable of providing the user with a variety of flavors or tastes. The vitamin mixtures may be a mixture of at least one of vitamin A, vitamin B, vitamin C, and vitamin E, but are not limited thereto. In addition, the liquid composition may include an aerosol forming agent such as glycerin and propylene glycol.

For example, the liquid composition may include any weight ratio of glycerin and propylene glycol solution to which nicotine salts are added. The liquid composition may include two or more types of nicotine salts. The nicotine salts may be formed by adding suitable acids, including organic or inorganic acids, to nicotine. Nicotine may be a naturally generated nicotine or synthetic nicotine and may have any suitable weight concentration relative to the total solution weight of the liquid composition.

Acids for forming the nicotine salts may be appropriately selected considering a blood nicotine absorption rate, an operation temperature of the aerosol generating device 10, flavors or tastes, solubility, and the like. For example, the acids for the formation of nicotine salts may be a single acid selected from the group consisting of benzoic acid, lactic acid, salicylic acid, lauric acid, sorbic acid, levulinic acid, pyruvic acid, formic acid, acetic acid, propionic acid, butyric acid, valeric acid, caproic acid, caprylic acid, capric acid, citric acid, niyristic acid, palmitic acid, stearic acid, oleic acid, linoleic acid, linolenic acid, phenylacetic acid, tartaric acid, succinic acid, fumaric acid, gluconic acid, saccharic acid, malonic acid or malic acid, or a mixture of two or more acids selected from the group, but embodiments are not limited thereto.

The cartridge 200 may include a cartridge body 203 configured to contain therein the aerosol generating material. For example, the cartridge body 203 may simply serve as a container for the aerosol generating material. As another example, the cartridge body 203 may include elements impregnated with (i.e., containing) the aerosol generating material such as a sponge, cotton, cloth, or a porous ceramic structure.

The aerosol generating device 10 may include the atomizer 12 configured to convert a phase of the aerosol generating material in the cartridge 200 to generate an aerosol.

For example, the atomizer 12 of the aerosol generating device 10 may convert the phase of the aerosol generating material by using an ultrasonic vibration method of atomizing the aerosol generating material through ultrasonic vibrations. The atomizer 12 may include an ultrasonic vibrator 300 configured to generate ultrasonic vibrations, a liquid delivery means 205 configured to absorb the aerosol generating material and maintain the same in an optimal state for conversion into the aerosol, and a vibration accommodation portion 204 configured to transmit the ultrasonic vibrations to the aerosol generating material of the liquid delivery means to generate an aerosol.

The vibration accommodation portion 204 may receive the vibrations generated from the ultrasonic vibrator 300 and convert the aerosol generating material transmitted from the cartridge body 203 into the aerosol.

The liquid delivery means 205 may deliver the liquid composition of the cartridge body 203 to the vibration accommodation portion 204. For example, the liquid delivery means 205 may be a wick including at least one of cotton fiber, ceramic fiber, glass fiber, and porous ceramic. However, embodiments of the present disclosure are not limited thereto.

According to an embodiment, the atomizer 12 may be implemented as a vibration receiver having a mesh shape or a plate shape configured to perform a function of absorbing the aerosol generating material and maintaining the same in an optimal state for conversion into the aerosol without using a separate liquid delivery means and a function of transmitting the vibrations to the aerosol generating material to generate an aerosol.

According to the embodiment shown in FIG. 2, the ultrasonic vibrator 300 and the atomizer 12 are arranged in the main body 100, and the vibration receiver 204 and the liquid delivery means 205 are arranged in the cartridge 200. However, embodiments of the present disclosure are not limited thereto. For example, the cartridge 200 may include the ultrasonic vibrator 300, the vibration receiver 204, and the liquid delivery means 205. In this case, when a portion of the cartridge 200 is inserted into the main body 100, the main body 100 may supply power to the cartridge 200 through a terminal (not shown) or transmit a signal related to an operation of the cartridge 200 to the cartridge 200, thereby an operation of the ultrasonic vibrator 300 may be controlled.

The cartridge body 203 of the cartridge 200 may include a portion made of transparent material such that the aerosol generating material accommodated in the cartridge 200 may be visually checked from the outside. For example, the mouthpiece 201 and the cartridge body 203 may be entirely made of transparent plastic or glass. Alternatively, only a portion of the cartridge body 203 may be made of a transparent material.

The cartridge 200 of the aerosol generating device 10 may include an aerosol discharge passage 206 and an airflow passage 207.

The aerosol discharge passage 206 may be formed in the cartridge body 203 to be in fluid communication with the discharge hole 202 of the mouthpiece 201. Therefore, the aerosol generated by the atomizer 12 may move along the aerosol discharge passage 206 and may be delivered to the user through the discharge hole 202 of the mouthpiece 201.

The airflow passage 207 is a passage through which air flows from the outside into the aerosol generating device 10. Air flowing in from the outside through the airflow passage 207 may be introduced into the aerosol discharge passage 206 or a space in which the aerosol is generated. Thereby, the vaporized particles generated from the aerosol generating material may be mixed with the air to form an aerosol.

For example, as shown in FIG. 2, the airflow passage 207 may surround the aerosol discharge passage 206. In that case, the aerosol discharge passage 206 and the airflow passage 207 may be in the form of a double tube in which the aerosol discharge passage 206 is arranged inside the air flow passage 207 and the air flow passage 207 is arranged outside the aerosol discharge passage 206. Therefore, air from the outside may flow in a direction opposite to a direction in which the aerosol moves from the aerosol discharge passage 206.

A structure of the airflow passage 207 is not limited thereto. For example, the airflow passage 207 may be a gap formed between the main body 100 and the cartridge 200 when the main body 100 and the cartridge 200 are coupled to each other, which is in fluid communication with the atomizer 12.

The horizontal cross-sectional shape of the aerosol generating device 10 may be approximately circular, oval, square, rectangular, or a cross-section of various types of polygons. However, the cross-sectional shape of the aerosol generating device 10 is not limited thereto, and the aerosol generating device 10 is not necessarily limited to a structure linearly extending in the longitudinal direction, For example, the aerosol-generating device 10 may have a streamlined shape for the user to easily hold the aerosol-generating device 10 by hand or may be bent at a predetermined angle in a specific area. Also, the horizon cross-sectional shape of the aerosol-generating device 10 may not be uniform along the longitudinal direction.

FIG. 3 is a perspective view of an aerosol generating device according to an embodiment.

Referring to FIG. 3, the aerosol generating device 10 according to an embodiment may include the cartridge 200 configured to contain an aerosol generating material, and the main body 100 configured to support the cartridge 200.

The cartridge 200 may be coupled to the main body 100 while accommodating the aerosol generating material therein. For example, a portion of the cartridge 200 may be inserted into the main body 100, or a portion of the main body 100 may be inserted into the cartridge 200, such that the cartridge 200 and the main body 100 are coupled to each other. For example, the main body 100 and the cartridge 200 may be coupled to each other by a snap-fit method, a screw coupling method, a magnetic coupling method, an interference fit method, etc., but methods of coupling the main body 100 to the cartridge 200 are not limited thereto.

The cartridge 200 may be detachably connected to the main body 100. As shown in FIG. 3, when the cartridge 200 is mounted on the main body 100, a portion of the cartridge 200 may be accommodated in the main body 100. The cartridge 200 may receive power from the main body 100 when mounted on the main body 100. A user may use the cartridge 200 coupled to the main body 100, and the cartridge 200 may be removed from the main body 100 to be replaced. Although not shown in FIG. 3, the main body 100 may include a power supply device such as a battery, an atomizer, and a sensor shown in FIG. 2, and may include general components of the aerosol generating device 10.

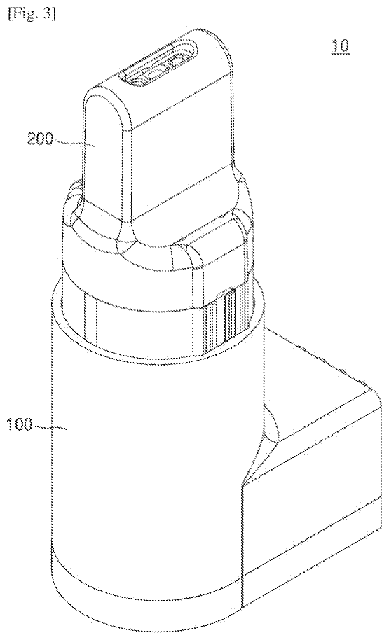

FIG. 4 is a perspective view of a cartridge of an aerosol generating device according to the embodiment shown in FIG. 3, and FIG. 5 is a cross-sectional view taken along line V-V′ of FIG. 4.

Referring to FIG. 4, the cartridge 200 may include the mouthpiece 201 and the cartridge body 203. A user may inhale an aerosol discharged through the discharge hole 202 of the mouthpiece 201. The cartridge body 203 may accommodate an aerosol generating material and include the ultrasonic vibrator 300 (see FIG. 5) configured to atomize the aerosol generating material to generate an aerosol.

The ultrasonic vibrator 300 may correspond to the ultrasonic vibrator 300 described with reference to FIG. 2.

The ultrasonic vibrator 300 may be arranged at a lower portion of the cartridge body 203. The ultrasonic vibrator 300 may vaporize or granulate the aerosol generating material by vibrating to generate an aerosol. The ultrasonic vibrator 300 may generate vibrations itself when electric power is applied to the ultrasonic vibrator 300, or receive vibrations from other components.

The ultrasonic vibrator 300 may generate vibrations of a short period (i.e., high frequency). Vibrations generated from the ultrasonic vibrator 300 may be ultrasonic vibrations, and a frequency of the ultrasonic vibrations may be, for example, 100 kHz to 3.5 MHz. By the short-period vibrations generated from the ultrasonic vibrator 300, the aerosol generating material may be vaporized and/or atomized into an aerosol.

The ultrasonic vibrator 300 may include, for example, a piezoelectric ceramic, which is a functional material configured to mutually convert the electricity and the mechanical force by generating electricity (i.e., voltage) from a physical force (i.e., pressure) and generating vibrations (i.e., mechanical force) when electricity is applied. Therefore, vibrations (i.e., physical force) are generated by the electricity applied to the ultrasonic vibrator 300, and the vibrations may generate an aerosol by atomizing the aerosol generating material into small particles.

Referring to FIG. 5, the cartridge 200 may include a liquid storage portion 208 configured to accommodate the aerosol generating material and a conveyer 209 configured to deliver the aerosol generating material to the ultrasonic vibrator 300. The conveyer 209 may be connected to the inside of the liquid storage portion 208. The conveyer 209 may be, for example, an element impregnated with (i.e., containing) the aerosol generating material, such as a sponge, cotton, cloth, or a porous ceramic structure. The conveyer 209 may correspond to the liquid delivery means 205 described with reference to FIG. 2.

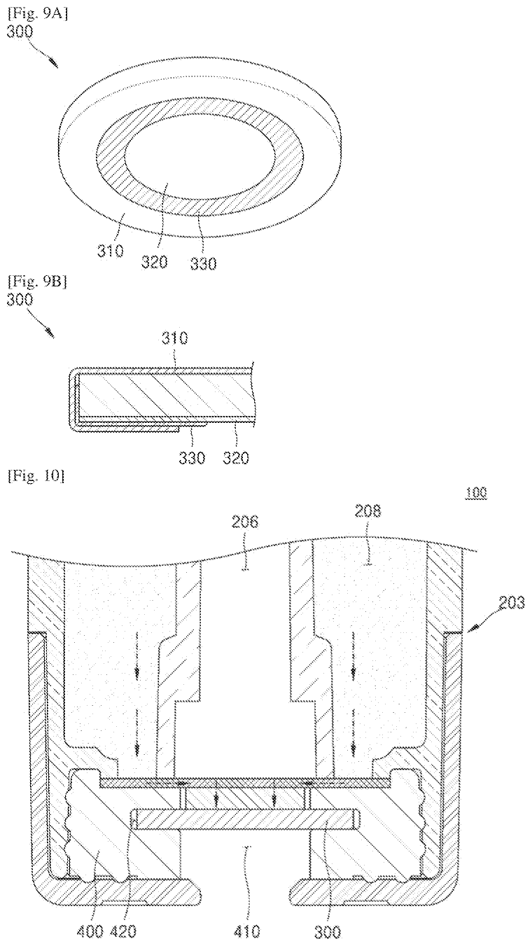

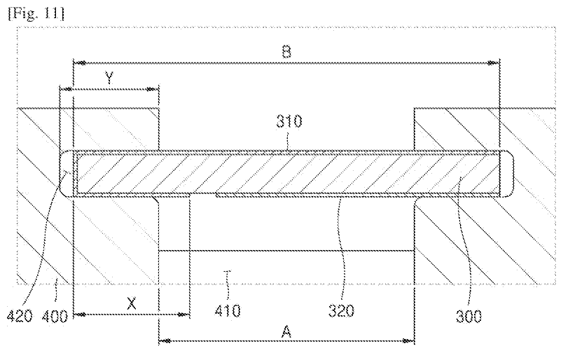

Referring to FIG. 10, the arrows indicate the movement direction of the aerosol generating material. That is, the aerosol generating material accommodated in the liquid storage portion 208 may be delivered to the ultrasonic vibrator 300 through the conveyer 209. The aerosol generating material may be delivered to one surface 301 of the ultrasonic vibrator 300 and atomized by the ultrasonic vibrator 300 to be aerosolized. The generated aerosol may move along the aerosol discharge passage 206 and be delivered to the, user through the discharge hole 202.

According to embodiments of the present disclosure, the one surface 301 of the ultrasonic vibrator 300 refers to either a front surface or a rear surface of the ultrasonic vibrator 300. In the descriptions of the present disclosure and the accompanying drawings, the one surface 301 of the ultrasonic vibrator 300 will be assumed to be a front surface arranged toward the aerosol discharge passage 206 through which the aerosol is discharged, and another surface 303 of the ultrasonic vibrator 300 will be assumed to be a rear surface opposite to the one surface 301 of the ultrasonic vibrator 300. The one surface 301 and another surface 303 of the ultrasonic vibrator 300 are not necessarily limited to the front and rear surfaces of the ultrasonic vibrator 300, respectively, and may be changed according to an arrangement structure of the cartridge 200. For example, the one surface 301 (e.g., a first surface) and another surface 303 a second surface) may refer to any difference surfaces of the ultrasonic vibrator 300 which face different directions. In other words, according to an appropriate structural change, the one surface 301 of the ultrasonic vibrator 300 may be the rear surface, and another surface 303 of the ultrasonic vibrator 300 may be the front surface.

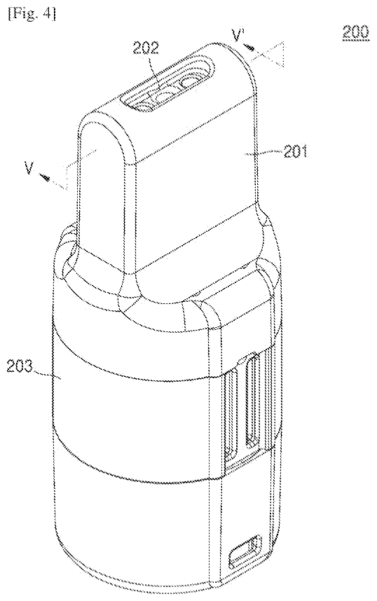

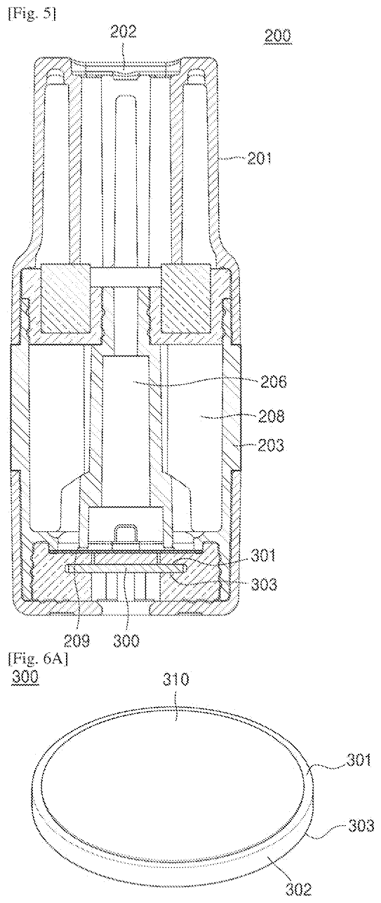

FIGS. 6A and 6B are perspective views of an ultrasonic vibrator of an aerosol generating device, according to an embodiment, More specifically, FIG. 6A is a plan perspective view of the ultrasonic vibrator 300, and FIG. 6B is a rear perspective view of the ultrasonic vibrator 300.

Referring to FIGS. 6A and 6B, the one surface 301 and another surface 303 of the ultrasonic vibrator 300 of the aerosol generating device 10 according to an embodiment may include electrodes 310 and 320 used as terminals configured to apply electrical energy. The electrodes 310 and 320 may receive power from a battery to drive the ultrasonic vibrator 300. The electrodes 310 and 320 may be formed on the one surface 301 and another surface 303 of the ultrasonic vibrator 300, respectively. For example, the electrodes 310 and 320 may be an anode and a cathode, respectively. Therefore, the anode and the cathode are required to be electrically insulated from each other. In addition, the anode and the cathode may be electrically connected to a power supply device, respectively, such that power may be applied thereto.

An electrode of the ultrasonic vibrator 300 may be formed by a silver baking method in which a silver (Ag) paste layer is formed on both surfaces of the ultrasonic vibrator 300 by screen printing and then heat-treated to be attached.

In this case, however, since the ultrasonic vibrator 300 is continuously exposed to a liquid aerosol generating material, the electrode may be worn out due to reaction with the liquid over time. In particular, a silver (Ag) electrode may be easily worn out due to cavitation and erosion that occur during vibration of an ultrasonic vibrator. If the electrode is worn out, the performance of the ultrasonic vibrator may significantly deteriorate, so the ultrasonic vibrator may not be able to smoothly perform a desired function, In addition, a method of forming an electrode using the silver paste is very sensitive to process variables, such as a heat treatment temperature, a pressure and temperature during a process, and the like.

According to embodiments, the electrodes 310 and 320 of the ultrasonic vibrator 300 may be deposited on one surface 301 and another surface 303 of the ultrasonic vibrator 300 by a deposition process. The deposition process may be a chemical vapor deposition (CVD) process, a physical vapor deposition (PVD) process, or an atomic layer deposition (ALD) process. The electrode may be formed by decomposing a certain material, such as TiN, DLC, TiCN, TiAiCN, AITiN, AlCrN, CrN, CrCN, ZrN, and/or ZrCN, into atoms through heating and particle collision, ionizing the atoms, and depositing the ionized material to a surface of the ultrasonic vibrator 300. The deposition process may be performed at or below 700° C.

The electrodes 310 and 320 of the ultrasonic vibrator 300 used in the aerosol generating device 10 according to embodiments may have a microhardness of about 200 Hv to about 9000 Hv, and a friction coefficient of about 0.01 to about 0.8. The electrodes 310 and 320 may have a thickness of about 0.5 μm to about 5 μm. The electrodes 310 and 320 having the thickness of about 0.5 μm to about 5 μm may be sufficient to seal the ultrasonic vibrator 300 without causing any defects due to a physical force caused by vibrations. Compared to the above-described Ag electrode, the deposited electrodes 310 and 320 have excellent durability and resistance to corrosion, even though there is no separate protective layer. As a result, the lifespan of the ultrasonic vibrator 300 may be extended and its stability may be improved.

Referring to FIGS. 6A and 6B, a first electrode 310 may be formed on the one surface 301 of the ultrasonic vibrator 300, and a second electrode 320 may be arranged on another surface 303 of the ultrasonic vibrator 300. Since the first electrode 310 and the second electrode 320 are formed on the opposite surfaces of the ultrasonic vibrator 300, respectively, they are electrically insulated from each other.

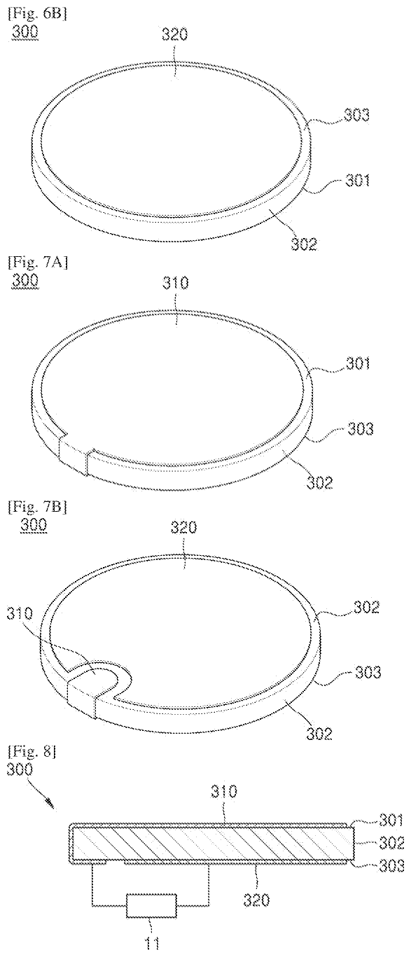

FIG. 7A is a perspective view of an ultrasonic vibrator of an aerosol generating device according to another embodiment, and FIG. 7B is a rear perspective view of an ultrasonic vibrator of an aerosol generating device according to another embodiment.

Referring to FIGS. 7A and 7B, the first electrode 310 arranged on the one surface 301 of the ultrasonic vibrator 300 may extend to another surface 303 of the ultrasonic vibrator 300. Referring to FIG. 7B, the first electrode 310 may cover a portion of the side surface 302 of the ultrasonic vibrator 300 to be arranged on a portion of another surface 303 of the ultrasonic vibrator 300. The ultrasonic vibrator 300 shown in the drawings has a disk shape, However, embodiments of the present disclosure are not limited thereto, and the ultrasonic vibrator 300 may have various shapes if necessary. For example, the first electrode 310 may also be formed on another surface 303 of the ultrasonic vibrator 300 without extending from one surface 302 to another surface 303 (i.e., without covering the side surface 302). In this case, for example, the first electrodes 310 formed on both surfaces may be electrically connected to each other internally.

As shown in FIG. 7B, the first electrode 310 may be formed on a portion of another surface 303 of the ultrasonic vibrator 300, and the second electrode 320 may be formed on the remaining portions of another surface 303 of the ultrasonic vibrator 300. In addition, the first electrode 310 and the second electrode 320 may be arranged apart from each other by a certain distance on another surface 303 of the ultrasonic vibrator 300 to be electrically insulated from each other.

On another surface 303 of the ultrasonic vibrator 300, the first electrode 310 and the second electrode 320 may have corresponding shapes at the boundary. For example, if the first electrode 310 on another surface 303 of the ultrasonic vibrator 300 has a curved shape, the portion of the second electrode 320 adjacent to the first electrode 310 may also be curved. Since the shapes of the first electrode 310 and the second electrode 320 correspond to each other at the boundary, a surface area of the electrode on another surface 303 of the ultrasonic vibrator 300 may be maximized.

FIG. 8 is a schematic side view of the ultrasonic vibrator shown in FIGS. 7A and 7B.

Since the first electrode 310 and the second electrode 320 have different polarities, voltages of different polarities are required to be applied from the outside. According to an embodiment, the first electrode 310 and the second electrode 320 are formed on opposite surfaces of the ultrasonic vibrator 300. Therefore, a power supply device such as a battery need to be electrically connected to both surfaces of the ultrasonic vibrator 300.

Referring to FIG. 8, in the case of the aerosol generating device 10 according to embodiments, since the first electrode 310 and the second electrode 320 are formed on the same surface of the ultrasonic vibrator 300, the ultrasonic vibrator 300 and the power supply device may be easily connected to each other. As illustrated in FIG. 8, if both the first electrode 310 and the second electrode 320 are arranged on another surface 303 of the ultrasonic vibrator 300, the power supply device may be arranged under the ultrasonic vibrator 300, and the ultrasonic vibrator 300 and the power supply device may be electrically connected to each other in a simple manner.

Therefore, since a separate lead wire or an internal structure is not required for front and rear surfaces of the ultrasonic vibrator 300 to be respectively connected to the power supply device, the ultrasonic vibrator 300 may have a simple structure. As a result, a manufacturing process may be simplified and a manufacturing cost may be reduced. In addition, the simple structure of the ultrasonic vibrator 300 makes it easy to attach a cartridge to and detach a cartridge from the ultrasonic vibrator 300, so that damage to the ultrasonic vibrator 300 may be prevented when attaching or detaching the cartridge.

In addition, even if an aerosol generating material comes into contact with the one surface 301 of the ultrasonic vibrator 300, the liquid aerosol generating material may be structurally separated from the power supply device because the power supply device is only connected to the another surface 303 of the ultrasonic vibrator 300. As a result, operational stability of the ultrasonic vibrator 300 may be improved.

FIG. 9A is a perspective view of an ultrasonic vibrator of an aerosol generating device, according to another embodiment, and FIG. 9B is a schematic side view of an ultrasonic vibrator of an aerosol generating device, according to another embodiment.

Referring to FIGS. 9A and 9B, the aerosol generating device 10 according to another embodiment may further include an insulator 330 configured to electrically insulate the first electrode 310 and the second electrode 320 from each other. The insulator 330 is an object in which electric current does not flow due to its significantly high resistance to electricity, and may be arranged between the first electrode 310 and the second electrode 320.

More specifically, the insulator 330 may extend from the side surface 302 of the ultrasonic vibrator 300 to another surface 303 of the ultrasonic vibrator 300, and may cover a portion of the second electrode 320 on another surface 303 of the ultrasonic vibrator 300. The first electrode 310 may extend from the one surface 301 of the ultrasonic vibrator 300 to a portion of the side surface 302 of the ultrasonic vibrator 300 such that the first electrode 310 is deposited on the insulator 330. In other words, the first electrode 310 is deposited only on a portion of another surface 303 of the ultrasonic vibrator 300 where the insulator 330 is located. Therefore, on another surface 303 of the ultrasonic vibrator 300, an area of the insulator 330 is greater than or equal to an area of the first electrode 310.

As shown in FIG. 9A, the insulator 330 may be disposed between the first electrode 310 and the second electrode 320 on another surface 303 of the ultrasonic vibrator 300. Therefore, the first electrode 310 and the second electrode 320 may be electrically insulated from each other by the insulator 330.

In order to implement easy connection between the ultrasonic vibrator 300 and a power supply device and increase the capacitance of the ultrasonic vibrator 300, it is preferable to maximize the surface areas of the first electrode 310 and the second electrode 320 on another surface 303 of the ultrasonic vibrator 300.

According to an embodiment, the surface areas of the first electrode 310 and the second electrode 320 may be increased when compared to FIG. 8, while the first electrode 310 and the second electrode 320 are electrically insulated from each other by the insulator 330. When the area of the insulator 330 formed on the other surface 303 of the ultrasonic vibrator 300 is equal to the area of the first electrode 310 deposited on the other surface 303 of the ultrasonic vibrator 300, the surface areas of the first electrode 310 and the second electrode 320 may be maximized while the first the electrode 310 and the second electrode 320 are electrically insulated from each other. As a result, the capacitance of the ultrasonic vibrator 300 may be increased and an aerosol may be efficiently generated.

FIG. 10 is an enlarged partial view of a cartridge shown in FIG. 5, and FIG. 11 is a schematic diagram illustrating an ultrasonic vibrator and a fixing member shown in FIG. 10.

Referring to FIG. 10, the aerosol generating device 10 according to embodiments may include a fixing member 400 configured to fix the ultrasonic vibrator 300 in the cartridge 200. At least a portion of the ultrasonic vibrator 300 may be inserted into the fixing member 400 such that the ultrasonic vibrator 300 is fixed inside the cartridge 200.

The fixing member 400 may include a hollow 410 and an insertion portion 420. The hollow 410 may be located at a center portion of the fixing member 400 and may extend in a longitudinal direction of the cartridge 200 (i.e., in parallel to the extending direction of the aerosol discharge passage 206). Therefore, the fixing member 400 may have a ring shape in which a through hole is formed at the center portion by the hollow 410.

The ultrasonic vibrator 300 may be electrically connected to a circuit by a pogo pin or a C-clip such that the ultrasonic vibrator 300 may receive a current or voltage from the pogo pin or the C-clip to generate vibrations. However, types of devices connected to the ultrasonic vibrator 300 to supply a current or voltage to the ultrasonic vibrator 300 are not limited thereto.

The hollow 410 may allow the cartridge 200 and the main body 100 to communicate with each other. For example, in the aerosol generating device 10 according to embodiments, the ultrasonic vibrator 300 (e.g., another surface 303) may be electrically connected to a power supply device through the hollow 410. The above-described pogo pin and C-clip may be connected to the ultrasonic vibrator 300 through the hollow 410. In addition, at least a portion of the ultrasonic vibrator 300 may be exposed to and contact an aerosol generating material through the hollow 410 such that an aerosol is generated by the ultrasonic vibrator 300.

The insertion portion 420 may be recessed in a direction crossing the hollow 410. At least a portion of the ultrasonic vibrator 300 is inserted into the insertion portion 420, and the remaining portions of the ultrasonic vibrator 300 are exposed to the hollow

Referring to FIG. 11, in a side view of the cartridge 200, a length X of a portion of the first electrode 310 deposited on another surface 303 of the ultrasonic vibrator 300 may be greater than a length Y of the insertion portion 420. Therefore, even while the ultrasonic vibrator 300 is inserted into the fixing member 400, the first electrode 310 on another surface 303 of the ultrasonic vibrator 300 may be exposed to the hollow 410 so that the exposed portion of the first electrode 310 can be electrically connected to a power supply device.

Referring to FIG. 11, a diameter A of the hollow 410 is smaller than a diameter B of the ultrasonic vibrator 300. Thus, while the ultrasonic vibrator 300 is inserted into the fixing member 400, a portion of the ultrasonic vibrator 300 may be exposed as much as the diameter A of the hollow 410.

Those of ordinary skill in the art related to the present embodiments may understand that various changes in form and details can be made therein without departing from the scope of the characteristics described above. The disclosed methods should be considered in a descriptive sense only and not for purposes of limitation. Therefore, the scope of the disclosure should be defined by the appended claims, and all differences within the scope equivalent to those described in the claims will be construed as being included in the scope of protection defined by the claims.

1. An aerosol generating device comprising:
a main body;
a cartridge detachably coupled to the main body and configured to contain an aerosol generating material; and
an ultrasonic vibrator arranged in the cartridge, comprising electrodes on different surfaces, and configured to vibrate the aerosol generating material,
wherein the electrodes are formed on the ultrasonic vibrator by deposition.

2. The aerosol generating device of claim 1, wherein thicknesses of electrodes are 0.5 μm to 5 μm.

3. The aerosol generating device of claim 1, wherein the electrodes comprise:
a first electrode arranged on a first surface of the ultrasonic vibrator; and
a second electrode arranged on a second surface of the ultrasonic vibrator, and
wherein the first electrode and the second electrode are electrically insulated from each other.

4. The aerosol generating device of claim 3, wherein
the first electrode extends from the first surface to the second surface, covering at least a portion of a side surface of the ultrasonic vibrator, and
the first electrode is apart from the second electrode on the second surface such that the first electrode is electrically insulated from the second electrode.

5. The aerosol generating device of claim 4, wherein a battery is electrically connected to the first electrode and the second electrode which are deposited on the second surface of the ultrasonic vibrator.

6. The aerosol generating device of claim 3, wherein
the first electrode extends from the first surface to the second surface, covering at least a portion of a side surface of the ultrasonic vibrator, and
the ultrasonic vibrator comprises an insulator extending from the side surface to the second surface and arranged between the first electrode and the second electrode on the second surface such that the first electrode is electrically insulated from the second electrode.

7. The aerosol generating device of claim 6, wherein, on the second surface of the ultrasonic vibrator, an area of the insulator is greater than or equal to an area of the first electrode.

8. The aerosol generating device of claim 1, wherein
the cartridge comprises a fixing member configured to fix the ultrasonic vibrator in the cartridge, and
the fixing member comprises a hollow extending in a longitudinal direction of the cartridge and an insertion portion recessed in a direction crossing the hollow, such that a portion of the ultrasonic vibrator is inserted into the insertion portion.

9. The aerosol generating device of claim 8, wherein
the electrodes comprise a first electrode and a second electrode, the first electrode is deposited on a first surface of the ultrasonic vibrator and extends to a second surface of the ultrasonic vibrator, covering at least a portion of a side surface of the ultrasonic vibrator, in a side view of the cartridge, a length of the first electrode on the second surface is greater than a length of the insertion portion such that the first electrode on the second surface is exposed to the hollow when the portion of the ultrasonic vibrator is inserted into the insertion portion, and
the second electrode is deposited on the second surface of the ultrasonic vibrator and electrically insulated from the first electrode.

10. The aerosol generating device of claim 8, wherein a diameter of the hollow is smaller than a diameter of the ultrasonic vibrator.

11. An aerosol generating device comprising:
a main body;
a cartridge detachably coupled to the main body and configured to contain an aerosol generating material;
an ultrasonic vibrator arranged in the cartridge and configured to vibrate the aerosol generating material;
a first electrode deposited on a first surface and a second surface of the ultrasonic vibrator; and
a second electrode deposited on the second surface of the ultrasonic vibrator.

12. The aerosol generating device of claim 11,
wherein the first electrode extends from the first surface to the second surface, covering a side surface of the ultrasonic vibrator, and
the second electrode is apart from the first electrode on the second surface such that the first electrode is electrically insulated from the first electrode.
